(19) United States
(12) Patent Application Publication
(10) Pub. No.: US 2005/0238542 A1
(43) Pub. Date: Oct. 27, 2005

(54) Pins for spotting nucleic acids

(75) Inventors: Julio P. Focaracci, San Mateo, CA (US); Tony S. Yan, South San Francisco, CA (US)

Correspondence Address: MILA KASAN, PATENT DEPT.;APPLIED BIOSYSTEMS, 850 LINCOLN CENTRE DRIVE, FOSTER CITY, CA, 94404, US

(73) Assignee: Applera Corporation, Foster City, CA (US)

(21) Appl. No.: 10/830,666

(22) Filed: Apr. 22, 2004

(51) Int. Cl. G01N 1/12

(52) U.S. Cl. 422/100; 73/864.72; 73/864.02; 73/863.31

(57) ABSTRACT

The present application relates to an apparatus and method for pins for spotting nucleic acids.

### FIELD

The present application relates to an apparatus and method for microarray spotting.

### INTRODUCTION

In the biological field, reactions on a solid surface can be used for hybridization assays. A known member of a binding pair on the solid surface can hybridize with a target member of the binding pair from the biological sample to form a duplex in the hybridization fluid. A pattern of duplexed binding pairs on the solid surface provides information about the biological sample. The pattern on the solid surface can be detected to map the information relative to the known members of the binding pairs on the solid surface. It is desirable to control the reliability of deposition or spotting of the known members of the binding pairs onto the solid surface or substrate so that information regarding whether the known members has hybridized with the target member can be accurate. Various nucleic acid solutions can be spotted on a substrate to form a microarray. The nucleic acids can be transferred from multi-well trays onto the surface of the substrate using spotting pins.

In operation, the spotting pin typically can contact and transfer a specific amount of nucleic acid solution onto, for example, a substrate surface. In various embodiments, the nucleic acid solutions for known members of the binding pairs can be provided to the spotting mechanism in, for example, 12, 24, 48, 96, 384, or 1536 well trays that can contain different known nucleic acid solutions in each well.

There are many factors that can influence the performance of the various spotting pins. For example, the pin material, surface finish, coatings, and treatments can affect, for example, the surface energy, hydrophilicity, and/or hydrophobicity of the pin. These factors can affect the amount of nucleic acid solution retained by the pin during transfer and deposited during spotting.

Presently available spotting pins provide problems related to controlling the reliability of nucleic acid solution retained and transferred by the pin. For example, if a spotting pin comes within close proximity to the well wall holding the nucleic acid solution, the surface energy of the vessel wall can affect the amount of material the spotting pin can retain when it is withdrawn from solution. In addition, for example, if a spotting pin contacts the wall of the well before the pin contacts the fluid in the bottom of the well, this may cause an insufficient amount of fluid to transfer onto the pin for later transfer to the substrate.

### SUMMARY

According to various embodiments, a pin for spotting nucleic acids comprises a substantially pointed tip portion, wherein the tip portion has a pin angle that substantially corresponds to a draft angle of a well for holding fluid containing the nucleic acids.

According to various embodiments, head for spotting nucleic acids comprises a plurality of pins, wherein each pin comprises a substantially pointed tip portion, and wherein each tip portion has a pin angle that substantially corresponds to a draft angle of a well for holding fluid containing the nucleic acids.

According to various embodiments, a system for microarray spotting comprises at least one spotting pin comprising a substantially pointed tip portion, and at least one well, the at least one well defining a well draft angle, wherein the tip portion has a pin angle that substantially corresponds to a draft angle of a well for holding fluid containing the nucleic acids.

According to various embodiments, a method for spotting a microarray comprises increasing nucleic acid fluid transfer to a substrate, substantially preventing a spotting pin from contacting a side of a well containing the nucleic acid fluid by providing a substantially pointed tip portion on the spotting pin having a pin angle that substantially corresponds to a draft angle of the well.

### BRIEF DESCRIPTION OF THE DRAWINGS

FIG. 1A illustrates a cross-sectional side view of a spotting system, including a spotting pin and a well;

FIG. 1B illustrates a cross-sectional side view of a spotting system including a tip region and a well;

FIG. 2A illustrates a cross-sectional side view of a spotting system including a spotting pin and a well, according to various embodiments;

FIG. 2B illustrates a cross-sectional side view of a spotting system including a tip region and a well, according to various embodiments;

FIG. 2C illustrates a top view of a spotting system including a triangular pin, according to various embodiments;

FIG. 2D illustrates a perspective view of a collar for a pin, according to various embodiments;

FIG. 2E illustrates a perspective view of a collar for a pin, according to various embodiments;

FIG. 2F illustrates a top view of 5 pins with adjacent collars, according to various embodiments;

FIG. 2G illustrates a side view of a tip region for a pin including a plurality of tips, according to various embodiments;

FIG. 2H illustrates side view of a tip region for a pin including a chamber, according to various embodiments;

FIG. 2I illustrates a cross-sectional top view of a pin including 3 grooves, according to various embodiments;

FIG. 3 illustrates a perspective view of a head for spotting nucleic acids, according to various embodiments; and

FIG. 4 illustrates a perspective view of a system for microarray spotting, according to various embodiments.

### DESCRIPTION OF VARIOUS EMBODIMENTS

In this application, the use of the singular includes the plural unless specifically stated otherwise. In this application, the use of “or” means “and/or” unless stated otherwise. Furthermore, the use of the term “including”, as well as other forms, such as “includes” and “included”, is not limiting. Also, terms such as “element” or “component” encompass both elements and components comprising one unit and elements and components that comprise more than one subunit unless specifically stated otherwise. Wherever possible, the same reference numbers will be used throughout the drawings to refer to the same or like parts.

The section headings used herein are for organizational purposes only, and are not to be construed as limiting the subject matter described. All documents cited in this application, including, but not limited to patents, patent applications, articles, books, and treatises, are expressly incorporated by reference in their entirety for any purpose.

The term “pin” as used herein refers to a component used to transfer nucleic acids to a surface of a substrate to form a microarray. In various embodiments, the pin can be constructed of any material including, but not limited to, metals, glass, plastic, and/or composite material that is compatible with microarray spotting. Several such materials are known to one skilled in the art of microarray spotting, including, but not limited to, titanium, tungsten, nitinol, and/or stainless steel. In various embodiments, the pin can be manufactured using a variety of methods known in the art of mechanical machining including, but not limited to, Electronic Discharge Machining (“EDM”), etc. In various embodiments, the pin can be plasma treated. In various embodiments, the pin can be slender or have a diameter substantially less than its length. In various embodiments, the pin can have any cross-sectional shape including, but not limited to, circular, triangular, rectangular, star-shaped, etc.

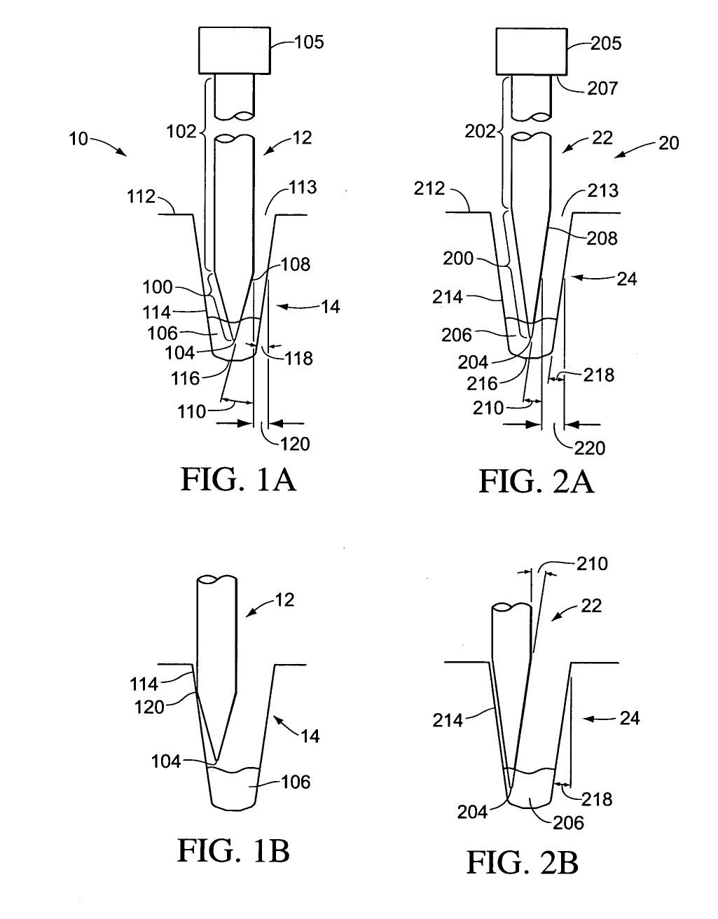

In various embodiments, FIG. 1A illustrates a pin 12. Pin 12 typically includes tip region 100 coupled to shaft 102. Tip region 100 can narrow, in cross-section, in a generally linear fashion from shaft 102 to tip 104. This narrowing can define a tip angle 110. Similarly, well 14 can define a well angled portion 114 that represents the generally linear narrowing of the cross-sectional diameter of well opening 113 to the diameter of well bottom 116. However, pin angle 110 is not equivalent to well angle 118. The difference in angle can lead to various difficulties and inefficiencies related to microarray spotting, as is discussed in more detail below.

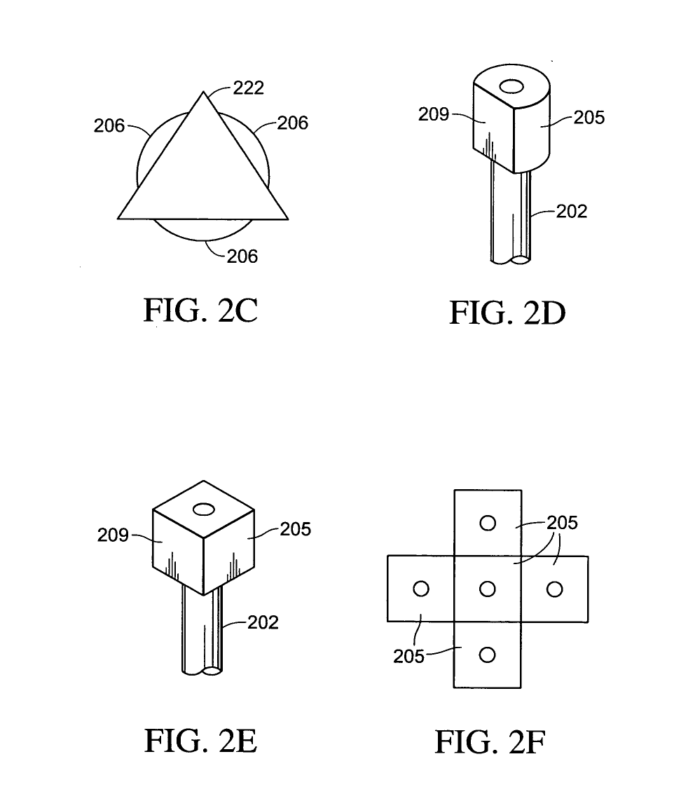

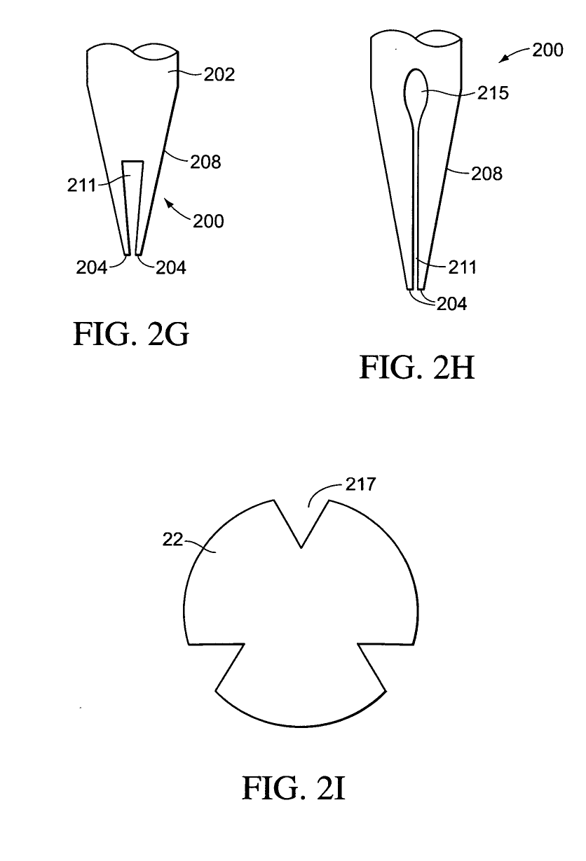

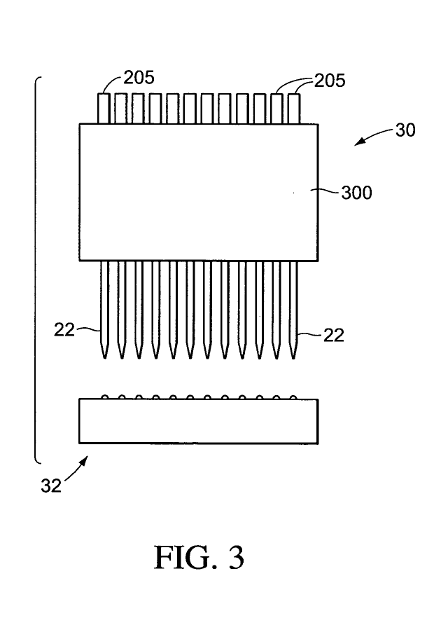

In various embodiments, as illustrated in FIG. 2A, a spotting system 20 can comprise a pin 22 and a well 24. In various embodiments, spotting system 20 can facilitate the precise transfer of a portion of fluid 206 from well 24 to a substrate 32 (see, e.g., FIG. 3), to facilitate microarray spotting, as is known in the art.

In various embodiments, as illustrated in FIG. 2A, pin 22 can comprise a tip region 200. In various embodiments, tip region 200 can be a separate component that couples to a shaft 202. In various embodiments, tip region 200 can be contiguous with shaft 202, for example, tip region 200 can be machined from shaft 202. In various embodiments, tip region 200 can include a tip 204 that can contact a fluid 206, that holds certain nucleic acids, located in well 24.

In various embodiments, tip region 200 can include a tip angled portion 208. In various embodiments, tip angled portion 208 can represent a generally-linear narrowing of a cross-section of pin 22 from shaft 202 to tip 204. In various embodiments, the slope of tip angled portion 208 can define a pin angle 210.

In various embodiments, well 24 can include a top surface 212, a well angled portion 214, and a bottom portion 216, that, in combination, can form a depression that can store fluid 206. In various embodiments, fluid 206 can hold one or more nucleic acids. In various embodiments, top surface 212 can define an opening 213, through which pin 22 can enter. In various embodiments, well angled portion 214 can represent a generally-linear narrowing of the cross-section of well 24 from opening 213 to bottom portion 216. In various embodiments, the slope of well angled portion 214 can define a well angle 218.

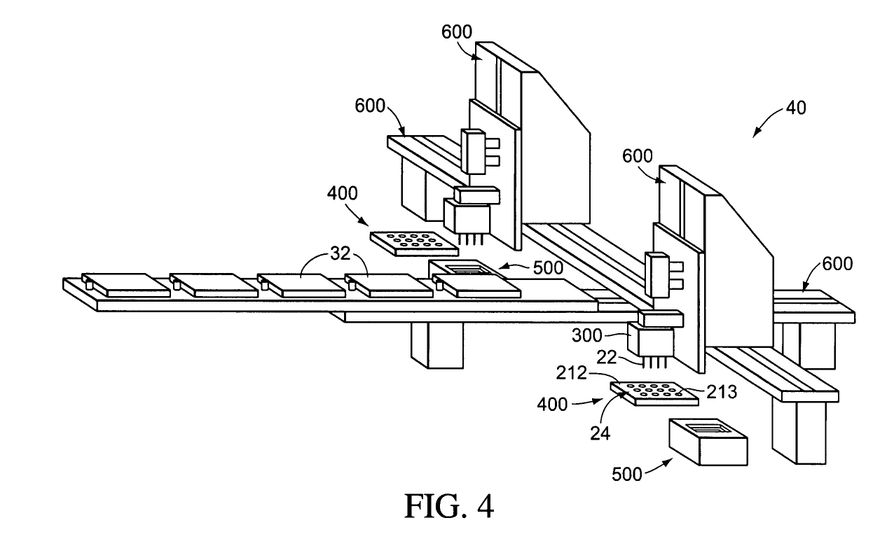

In various embodiments, tip angle 210 can be substantially equivalent to well angle 218. In various embodiments, this can allow for tip 204 to contact fluid 206 even when pin 22 is not aligned centrally within well 24. For example, as illustrated in FIG. 1B, when pin 12 is not centrally aligned with well 14, pin 12 can contact well angled portion 114 at a point 120 and can thus prevent tip 104 from contact with fluid 106. This error can result in transferring little or no nucleic acids to substrate 32 of a microarray spotting apparatus (see, e.g., FIGS. 3 and 4). In contrast, in various embodiments, FIG. 2B illustrates pin 22 misaligned with the center of well 24, however, due at least in part to the similarity of pin angle 210 to well angle 218, tip 204 can still contact fluid 206 to facilitate transfer of one or more nucleic acids to substrate 32 (see, e.g., FIG. 3).

In various embodiments, as illustrated by FIGS. 1A and 2A, the proximity of tip angled portion 108 or 208 to well angled portion 114 or 214 can define a gap 120 or 220. When pin 12 comes within closer proximity to well 14 (e.g., when gap 120 is small), a greater surface tension acts to pull fluid away from pin 12 when pin 12 is removed from well 14. In various embodiments, pin angle 210 can facilitate an increased gap 220 size in comparison to the size of gap 120 when pin angle 110 does not substantially correspond to well angle 118. In various embodiments, this greater gap size can reduce the amount of fluid 206 pulled away from pin 22 due to surface tension with well angled portion 214 when pin 22 is removed from well 24.

In various embodiments, shaft 202 can be circular in cross-section. In various embodiments, shaft can be rectangular in cross-section. In various embodiments, tip region 200 can comprise a separate component from shaft 202 that can attach to shaft 202 through various coupling means. For example, in various embodiments, tip region 200 can include a threaded portion (not shown) that can screw into a corresponding threaded portion located on shaft 202. Other coupling means include, but are not limited to, attachment by electromagnetism, mechanical interlocks, etc. In various embodiments, pin 22 can comprise a collar 205 to facilitate coupling of pin 22 to spotting head (e.g., FIGS. 2D-2E), as is discussed in more detail below.

In various embodiments, as illustrated in FIG. 2C, pin 222 can have a triangular cross-section. FIG. 2C is a cross sectional view of pin 222 showing the retention of fluid 206 on each of the three faces of the triangular cross-section. The angular surfaces create surface tension on pin 222 so that fluid 206 can be retained on pin 222. Pin 222 can have a pin angle 210 (e.g., FIG. 2A) substantially corresponding to well angle 218 (e.g., FIG. 2A).

In various embodiments, as illustrated in FIG. 3, a plurality of pins 22 can be coupled to a spotting head 300. In various embodiments, spotting head 300 can be used to synchronize movement of a plurality of pins 22 to facilitate spotting of numerous nucleic acids at one time. In various embodiments, spotting head 300 can hold a number of pins 22 including, but not limited to, 1, 2, 4, 8, 12, 24, 48, 96, 384, and 1536.

In various embodiments, as illustrated in FIGS. 2D and 2E, pin 22 can include collar 205 to facilitate coupling of pin 22 to spotting head 300. In particular, in various embodiments, collar 205 can comprise a shoulder 207 that can contact a corresponding ledge (not shown) within spotting head 300, as is known in the art. In various embodiments, this contact can prevent a downward movement of pin 22 with respect to spotting head 300, but can allow for upward movement, if necessary. In various embodiments, collar 205 can comprise a shape that prevents rotation of pin 22. For example, as illustrated in FIGS. 2D and 2E, collar 205 can comprise a flat region 209 that can interface with a corresponding flat region (not shown) located in spotting head 300. In various embodiments, collar 205 can attach to pin 22 using various coupling means. For example, in various embodiments, collar 205 can include a threaded portion (not shown) that can allow collar 25 to be screwed onto a corresponding threaded portion (not shown) located on pin 22.

In various embodiments, as illustrated in FIG. 2E, collar 205 can be rectilinear. Such rectilinear collars can provide control from rotation by abutting to adjacent collars such that each collar prevents at least one other collar from rotating. For example, FIG. 2F illustrates a top view of five pins arranged in a cross-linear configuration. With a square geometry, each collar can prevent up to four other collars from rotating. Rectilinear geometries of polygons with more than four sides can provide additional configurations.

In various embodiments, tip region 200 can include a tip 204. In various embodiments, as illustrated in FIG. 2G, tip region 200 can comprise a plurality of tips 204 that can define a channel 211 in between them. In various embodiments, the plurality of tips 204 can provide additional surface area to transfer more nucleic acid solution to substrate 32 (see, e.g., FIG. 3), thereby increasing the efficiency of a microarray spotting system 40 (see, e.g., FIG. 4). In various embodiments, as illustrated in FIG. 2H, the plurality of tips 204 can define a chamber 215. In various embodiments, chamber 215 can contain additional fluid 206, which can increase the transfer of nucleic acid solution to substrate 32. In various embodiments, the plurality of tips 204 and/or chamber 215 can be machined from tip region 200 and/or shaft 202 using various methods known in the art (e.g., EDM).

In various embodiments, as illustrated in FIG. 21, pin 22 can comprise at least one groove 217. In various embodiments, groove 217 can increase the surface area of pin 22 to facilitate the retention of more fluid 206. In various embodiments, groove 217 can be a “V-type” notch in the cross-section of pin 22. In various embodiments, groove 217 can be a rectangular cutout in the cross section of pin 22. In various embodiments, groove 217 can extend longitudinally along the length of pin 22. In various embodiments, groove 217 can spiral around pin 22. In various embodiments, groove 217 can extend along a portion of the length of pin 22. In various embodiments, groove 217 can take the form of a knurl or other similar surface treatment to pin 22.

In various embodiments, as illustrated in FIG. 4, spotting head 300 can couple to a system for microarray spotting (“system”) 40. In various embodiments, system 40 can be a robotic platform for automated spotting by multiple spotting heads 300 that alternate loading from multi-well trays 400 and washing in washing stations 500. In various embodiments, system 40 can incorporate a conveyor for one or more substrates 32. System 40 can include a plurality of linear actuators 600 for positioning substrates 32, positioning spotting heads 300 over substrates 32, and lowering spotting heads 300 such that pins 22 contact substrate 32 to form at least a portion of the spots of nucleic acid that make up the microarray.

In various embodiments, pin angle 210 can prevent pin 22 from contact with well 24, by providing a larger gap 220 (see, e.g., FIG. 2A), as is discussed in more detail above. In various embodiments, larger gap 220 can provide more space to allow more fluid 206 to transfer onto substrate 32 via pin 22.

Other various embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A pin for spotting nucleic acids, the pin comprising:
a substantially pointed tip portion,
wherein the tip portion has a pin angle that substantially corresponds to a draft angle of a well for holding fluid containing the nucleic acids.

2. The pin of claim 1, wherein the pin angle substantially prevents the pin from contacting a side of the well.

3. The pin of claim 2, wherein the fluid is not substantially pulled away from the pin by surface tension with the side of the well.

4. The pin of claim 1, further comprising a shaft with a proximate end and a distal end, wherein the proximate end forms at least one tip.

5. The pin of claim 4, wherein the proximate end comprises two split tips forming a channel.

6. The pin of claim 5, wherein the channel expands to a chamber.

7. The pin of claim 4, wherein the proximate end comprises a groove.

8. The pin of claim 4, wherein at least the proximate end is constructed of a material chosen from tungsten, stainless steel, titanium and nitinol.

9. The pin of claim 4, wherein at least the proximate end is plasma treated.

10. The pin of claim 1, wherein the pin has a triangular cross-section.

11. A head for spotting nucleic acids, the head comprising:
a plurality of pins, wherein each pin comprises a substantially pointed tip portion, wherein each tip portion has a pin angle that substantially corresponds to a draft angle of a well for holding fluid containing the nucleic acids.

12. The head of claim 11, wherein the pin angle substantially prevents the pin from contacting a side of the well.

13. The head of claim 12, wherein the fluid is not substantially pulled away from the pin by surface tension with the side of the well.

14. The head of claim 11, wherein each pin further comprises a shaft with a proximate end and a distal end, wherein the proximate end comprises at least one tip.

15. The head of claim 14, wherein the distal end comprises a collar.

16. The head of claim 15, wherein the collar of at least one pin substantially prevents rotation of at least one different pin.

17. The head of claim 11, wherein the head is configured to hold a number of pins selected from 1, 2, 4, 8, 12, 24, 48, 96, 384, and 1536.

18. A system for microarray spotting, the system comprising:
at least one spotting pin comprising a substantially pointed tip portion; and
at least one well, the at least one well defining a well draft angle,
wherein the tip portion has a pin angle that substantially corresponds to a draft angle of a well for holding fluid containing the nucleic acids.

19. The system of claim 18, further comprising a head for spotting nucleic acids, wherein the head comprises a plurality of pins coupled to the head.

20. The system of claim 19, further comprising at least one linear actuator coupled to the head, wherein the linear actuator allows for automated movement of the head.

21. The system of claim 20, further comprising means for translating a plurality of substrates for microarray spotting.

22. A method for spotting a microarray, the method comprising:
increasing nucleic acid transfer to a substrate;
substantially preventing a spotting pin from contacting a side of a well containing the nucleic acid fluid by providing a substantially pointed tip portion on the spotting pin having a pin angle that substantially corresponds to a draft angle of the well.

23. The method of claim 22, further comprising:
substantially preventing the nucleic acid fluid from providing surface tension with the side of the well.

24. The method of claim 22, further comprising aligning the pin with the well.

25. A system for microarray spotting, the system comprising:
means for spotting;
wherein the means for spotting substantially prevents a nucleic acid from providing surface tension with a side of a well.

26. The system of claim 25, further comprising means for automating the means for spotting.
